(19) United States
(12) Patent Application Publication
(10) Pub. No.: US 2020/0115568 A1
(43) Pub. Date: Apr. 16, 2020

(54) PREPARATION OF CHEMICALLY AND THERMALLY STABLE ISOCYANATE MICROCAPSULES AND APPLICATIONS THEREOF

(71) Applicant: The Hong Kong University of Science and Technology, Hong Kong (CN)

(72) Inventors: Jinglei YANG, Hong Kong (CN); Dawei SUN, Beijing (CN); Ying ZHAO, Hong Kong (CN)

(21) Appl. No.: 16/597,245

(22) Filed: Oct. 9, 2019

Related U.S. Application Data
(60) Provisional application No. 62/766,265, filed on Oct. 11, 2018.

(51) Int. Cl. C09D 7/40; C09D 163/00; B01J 13/16; B01J 13/22

(52) U.S. Cl. CPC C09D 7/70; C09D 7/69; B01J 13/22; B01J 13/16; C09D 163/00

(57) ABSTRACT

A DL microcapsule is formed that has a core-double layer shell structure with a liquid diisocyanate comprising molecule core and a double layer shell. The double layer shell has an inner layer comprising a polyurea (PU) and an outer layer comprising a poly(urea formaldehyde) foam (PUF). A self-healing coating is formulated from a multiplicity of DL microcapsules in a polymeric matrix. A polymer matrix can be formed by the polyaddition of an epoxy resin. A self-healing coated substrate is formed by applying the self-healing coating precursor that combines DL-microcapsules with an uncured polymeric resin as a dispersion on a substrate and curing the polymeric resin. The self-healing coated substrate is capable of resisting corrosion when abraded. The substrate can be any metal substrate, for example an iron or steel substrate. The polymeric resin can be an epoxy resin.

### CROSS-REFERENCE TO RELATED APPLICATION

This application claims the benefit of U.S. Provisional Application Ser. No. 62/766,265, filed Oct. 11, 2018, which is hereby incorporated by reference in its entirety including any tables, figures, or drawings.

### BACKGROUND OF THE INVENTION

Evolving from self-healing composites, self-healing coatings are of particular interest due to their efficiency in steel anticorrosion application. Self-healing anticorrosion performances were normally realized through embedded microcapsules, which in broken cases automatically release healing agents into crack areas to recover the protective life of coatings. Traditional double-component healing chemistry required stoichiometric amounts of different active agents at damaged areas for satisfactory performance. This process is uncontrolled. To address this problem one-component healing chemistry is of interest, where cure of healing agents is initiated by ambient light, moisture, or oxygen. Of potential one-component healing agents, water reactive isocyanates are attractive due to an ease of inclusion and their high anticorrosion performances.

When isocyanates as healing agents are applied in anticorrosion coatings, the impermeability of microcapsules to water and organic solvents must be considered. Microcapsules shells are typically fabricated using interfacial or in situ protocols, where the shells include inorganic fillers boosting crosslink density, and generating multi-layered structures to improve robustness. Wu et al. Mater. Chem. A, 2, (2014) 11614-20 and Adv. Funct. Mater. 24, (2014) 6751-61, discloses hybrid shells and highly cross-linked poly urea formaldehyde foam PUF shells to load hexamethylene diisocyanate (HDI) and impart a longer lifetime of the microcapsules in organic solvents. Sun et al. J. Mater. Chem. A, 3, (2015) 4435-44. discloses encasement of HDI in double-layered polyurea PU shells for improved stability in organic solvents. Yi et al., J. Mater. Chem. A, 3 (2015) 13749-57 discloses the synthesis of hybrid shell-layers using Pickering emulsions, where the final microcapsules (isophorone diisocyanate as core) shows exceptional stability in water. Sun et al., Polymer 91, (2016) 33-40 discloses forming double-layered PUF/PU shells to boost the service life of encapsulated 4,4′-bis-methylene cyclohexane diisocyanate (HMDI) in water. Nguyen et al., Polym. Chem., 6 (2015) 1159-70 discloses the loading of HDI within hydrophobic microcapsules that show a stable core fraction in water for a day. Li et al., Compos. Sci. Technol. 123, (2016) 250-8. discloses thioether microcapsules to encase isophorone diisocyanate (IPDI), where the final core content dropped by 18% after a week in water. Clearly, microcapsules with long-term viability in organic solvent and water are still needed.

Self-lubricating coatings is another promising application that can be addressed with microcapsules. Khun et al., J. Appl Mech. Trans. ASME 81, (2014) 7 discloses microcapsules with liquid wax cores to improve the self-lubricating performance of epoxy coatings. Bandeira et al. discloses polysulphone microcapsules containing ionic liquids into coatings with lower friction coefficient. Based on a similar mechanism, encapsulated lubricants such as tung oil, oleylamine, and methylsilicone oil provide self-lubricating composites. Nevertheless, there remains a lack of self-healing coatings with both self-healing and self-lubricating performances.

### BRIEF SUMMARY OF THE INVENTION

An embodiment of the invention is directed to DL microcapsules. The DL microcapsules have a core-double layer shell structure comprises a liquid diisocyanate comprising molecule core and a double layer shell, where the double layer shell has an inner layer comprising a polyurea (PU) and an outer layer comprising a poly(urea formaldehyde) (PUF). The liquid diisocyanate comprising molecule can be any liquid diisocyanate molecule or mixture of molecules including 4,4′-bis-methylene cyclohexane diisocyanate and hexamethylene diisocyanate. The DL microcapsules have a diameter of is 50 to 200 μm and a double layer shell thickness of 387±40 nm for PUF layer and 3.5±0.2 μm for PU layer. The PU inner layer can be formed from any polyurea formulation, for example, the PU from the polyaddition of a 4,4-Diphenylmethane diisocyanate prepolymer and 4,4′-bis-methylene cyclohexane diisocyanate with tetraethylenepentamine.

An embodiment of the invention is directed to a self-healing coating, comprising a multiplicity of DL microcapsules in a polymeric matrix. The polymer matrix can be any polymeric matrix for example an epoxy matrix. The epoxy matrix can be one formed as the polyaddition product from 2,2-Bis(4-glycidyloxyphenyl)propane and isophorone diamine.

An embodiment of the invention is directed to a method of forming a self-healing coated substrate where a coating precursor comprising the DL-microcapsules and a polymeric resin is dispersed on a substrate and curing the polymeric resin to form the self-healing coating on the substrate. The self-healing coated substrate is capable of resisting corrosion when abraded. The substrate can be any metal substrate, for example an iron or steel substrate. The polymeric resin can be an epoxy resin.

### BRIEF DESCRIPTION OF THE DRAWINGS

FIG. 1A shows an SEM image of DL microcapsules with a distribution of diameters, according to an embodiment of the invention.

FIG. 1B shows an SEM image of a single DL microcapsule displaying its smooth surface, according to an embodiment of the invention.

FIG. 1C shows an SEM image of a broken DL microcapsule displaying its smooth surface with little solids decoration the inner surface.

FIG. 1D shows an SEM image of a cross-section of the shell.

FIG. 2A shows an ¹H NMR spectra of pure HMDI.

FIG. 2B shows an ¹H NMR spectra of fluid extracted from the core of the DL microcapsule.

FIG. 3 shows TGA curves of intact DL microcapsules, shell materials, pure HMDI, and of broken microcapsules where the temperature is raised from room temperature to 600° C. at a rate of 10° min⁻¹ under a N₂ atmosphere.

FIG. 4A shows an SEM image of a broken IL microcapsule in water.

FIG. 4B shows an SEM image of collapsed IL microcapsules in hexane.

FIG. 4C shows an SEM image of a broken DL microcapsule in water.

FIG. 4D shows an SEM image of a broken DL microcapsule in hexane.

FIG. 5A shows a plot of the mass fraction of core material of the DL microcapsules vs immersion time in water.

FIG. 5B shows an SEM image of DL microcapsules after 20 days in ambient water.

FIG. 6 shows a plot of the mass fraction of core material of the DL microcapsules vs immersion time in various organic solvents.

FIG. 7A shows a bar graph of the core mass fraction of DL microcapsules of various diameters before and after immersion in ethyl acetate for five days with an insert of the SEM image of the cross-section of the shell.

FIG. 7B shows a plot of the core mass fraction of DL microcapsules as a function of the weight percent of the DL microcapsules in ethyl acetate for five days.

FIG. 8A shows an image of an epoxy coated steel substrate with a scribe of the coated surface after 20 days in salt water.

FIG. 8B shows an image of an epoxy coated steel substrate with two scribes of the coated surface with magnification of the corrosion in the scribe after 20 days in salt water.

FIG. 8C shows an image of a self-healing coating comprising a DL microcapsule filled epoxy coated steel substrate with a scribe of the coated surface after 20 days in salt water.

FIG. 8D shows an image of an epoxy coated steel substrate with two scribes of the coated surface with magnification of the healing of the scribed surface after 20 days in salt water.

FIG. 9 shows a plot of the resistance (R_{healing}) of self-healing coating samples plotted as a function of immersion time in a 1M NaCl solution.

FIG. 10A shows a plot of the friction coefficient of a pure epoxy and a self-healing coating as a function of wear laps.

FIG. 10B shows a bar graph of the wear width and wear depth formed after a tribological tests conducted with a 6 mm rolling steel ball a ball-on-disc micro-tribometer.

FIG. 10C shows the topography of a pure epoxy sample after tribological test.

FIG. 10D shows the topography of a self-healing coating sample after tribological test.

### DETAILED DISCLOSURE OF THE INVENTION

An embodiment of the invention is directed to a double-layer (DL) microcapsule comprising an inner-layered polyurea (PU) shells surrounded by an outer-layered polyurea formaldehyde foam (PUF) shells that encapsulates a liquid comprising a diisocyanate, for example HMDI for use in self-healing and self-lubricating coatings. According to an embodiment of the invention, the PU shell is synthesized by an interfacial polymerization in an oil/water emulsion. Using an oligoamine, for example, tetraethylenepentamine (TEPA) as crosslinker, polyurea shells with very high crosslink density are formed. The crosslink density is significantly higher than that of traditional used polyurethane shells. Because of the high reactivity of amines with isocyanates, coalescence microcapsules can occur upon oligoamine addition to the emulsion. To assure well-dispersed microcapsules, the numbers of NCO functional groups residing on droplets surfaces was reduced by extending the duration of emulsification. The PUF layer is formed by in situ polymerization on the surfaces of the PU shells. Acid promoted polymerization of a urea-formaldehyde prepolymer that is synthesized by reacting urea and formaldehyde in an alkaline environment, allowing a high crosslink density of PUF shells.

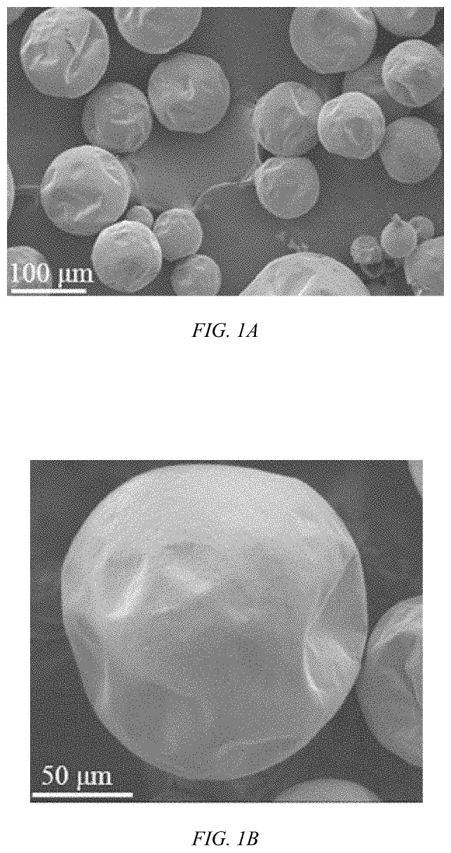

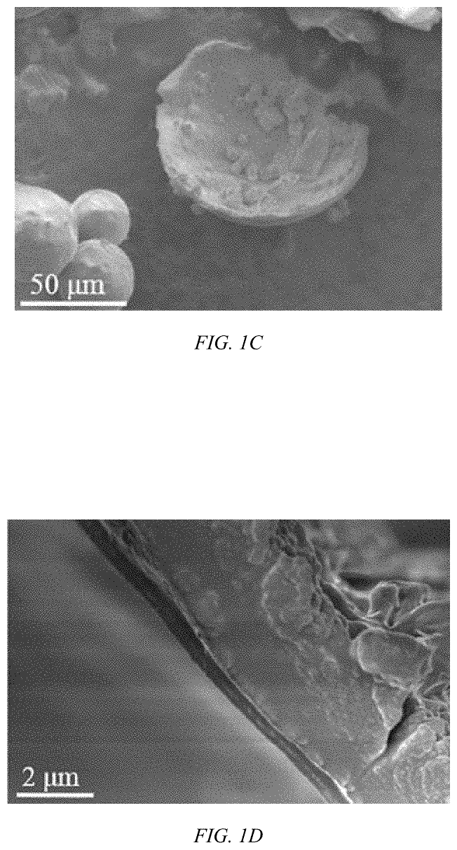

Exemplary DL microcapsules with a mean diameter of 80±22 μm are shown in FIG. 1A. As shown in FIGS. 1B and 1C, the DL microcapsules have a smooth and dense outer surface and hollow inner structure. The cross-section of the DL shell, as shown in FIG. 1D displays the double-layer structure. The average shell thickness of microcapsules was 3.8±0.2 μm with PUF and polyurea shell thicknesses of 387±40 nm and 3.5±0.2 respectively.

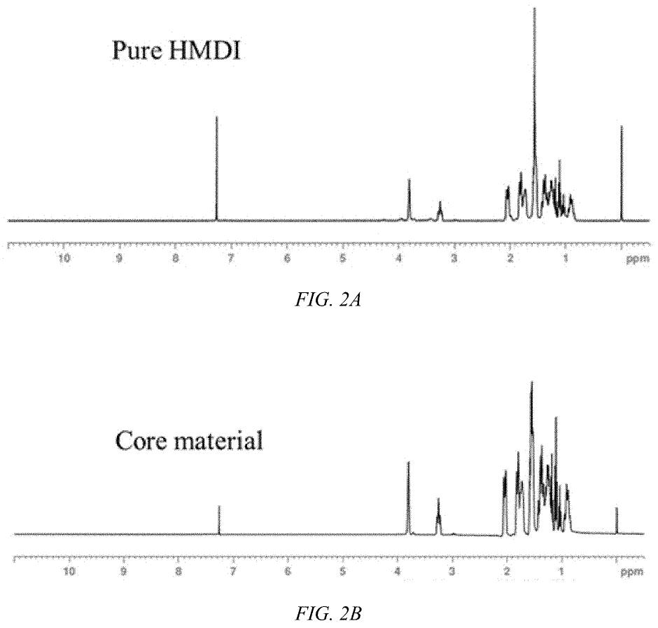

The chemical composition of core material is confirmed to be HMDI by ¹H NMR spectroscopy analysis. As shown in FIG. 2B, the spectrum of core material was consistent with that of a pure HMDI sample of FIG. 2A. The core fraction of the DL microcapsules is unaltered HMDI, where titration of exemplary microcapsules indicated 74±1.3 wt % HMDI, which is effectively equal to theoretical value of 73±4.6 wt %. The theoretical core fraction of microcapsules is estimated as the relationship:

$$\frac{{ρ}_{HMDI}}{{ρ}_{polyurea}} {( \frac{D - 2 * S}{D} )}^{3}$$

where D is the diameter and S is the shell thickness of the DL microcapsules. From SEM images, D is 80±22 S is 3.8±0.2 μm, ρ_{HMDI} is 1.066 g/cm³, and ρ_{polyurea} is 1.066 g/cm³.

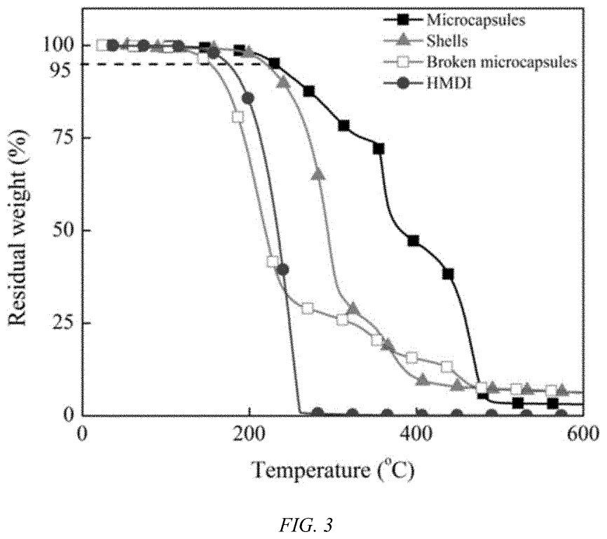

The thermal stability of DL microcapsules is high, as assessed by TGA. The mass loss all materials is plotted in FIG. 3 as a function of temperature. Initial shell material loss, as indicated by a mass decrease of 5 wt %, commenced at 220° C. with complete degradation at 600° C. leaving approximately 7.2 wt % residue. The initial mass loss of other materials commenced at: 174° C. for pure HMDI; 230° C. for the DL microcapsules; and 153° C. for broken microcapsules, respectively. The high initial mass loss temperature indicated excellent thermal stability of the DL microcapsules, demonstrating impermeable shells that trap HMDI vapor at temperatures higher than the boiling point of 168° C. for pure HMDI. Even with some shell loss at 220° C., more than 90% of the HMDI core was retained.

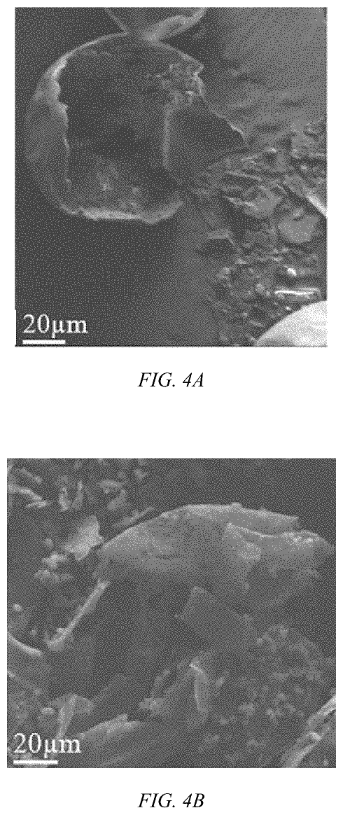

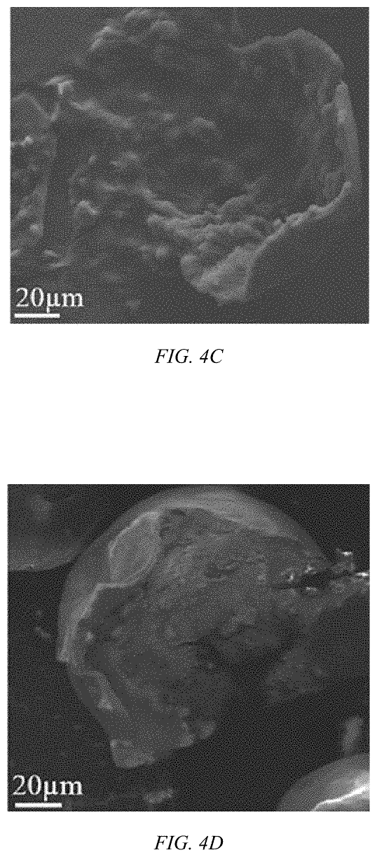

The permeability of PU and PUF shells was evaluated by the stability of IL-microcapsules and DL-microcapsules in water and hexane, respectively. IL-microcapsules and DL-microcapsules soaked in water at ambient for 20 days demonstrate the water resistance of the PU shell and PUF shell, respectively. As shown in FIGS. 4A and 4B, both microcapsules are hollow. The core fraction of IL-microcapsules and DL-microcapsules decreases from 91.6±0.8 wt % to 73.0±2.2 wt % and 74.1±1.3 wt % to 69.6±3.1 wt %, respectively. The impermeable PU shells allowed little water diffusion into the microcapsules, with only a minor decrease of core fraction, with the encapsulated HDI being depleted completely after 48 h in ambient water. In addition, both IL and DL microcapsules stored in hexane for 5 days differ significantly in stability. As shown in FIG. 4C, IL-microcapsules collapse completely with all HMDI being extracted from the core, whereas DL-microcapsules remained spherical, as shown in FIG. 4D with a marginal decrease of core fraction from 74.1±1.3 wt % to 72.2±1.0 wt %, indicating the good stability of the DL microcapsules in organic solvents.

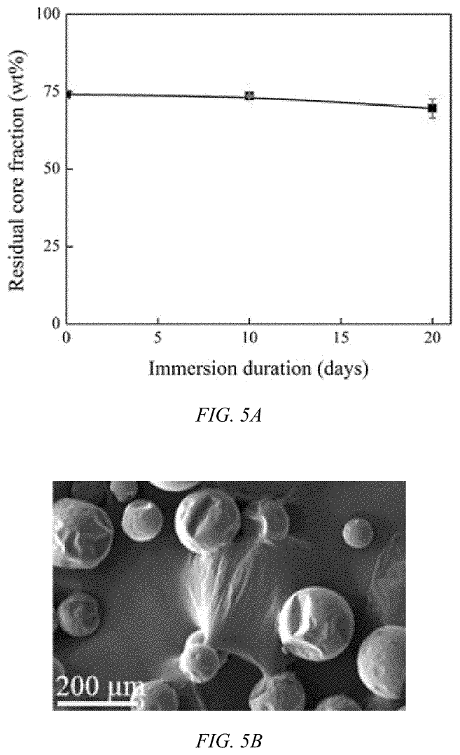

The stability of microcapsules in water of encapsulated isocyanates is important for anticorrosion applications in humid environments. The HDMI in DL microcapsules immersed in ambient water for different periods of time reflects their water resistance. The residual core fraction of the DL microcapsules for 0, 10, and 20 days is shown in FIG. 5A. With time, core mass fraction of the microcapsules decreased from 74.1±1.3, to 73.6±1.3 wt %, and to 69.6±3.1 wt %. More than 90% of original core is intact after 20 days. Moreover, the morphology of residual microcapsules retains the smooth outer surface, as shown in FIG. 5B. The outstanding stability of microcapsules to water is primarily attributed to an impermeable inner PU shell.

In commercial coatings, organic solvents are often used to assist coating operations, requiring good stability of embedded microcapsules. DL-microcapsules with a range of diameters soaked in various organic solvents at different concentrations for various periods of time reflect the stability of the microcapsules by residual core mass fraction and shell morphology. Parameters of concern include immersion time, solvent polarity, microcapsules size and concentrations.

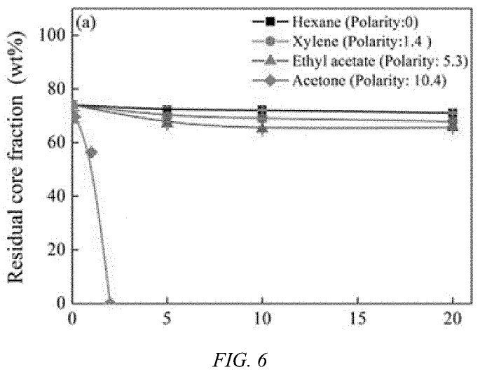

DL microcapsules immersed in hexane, xylene, ethyl acetate and acetone for different times displayed core mass fraction that are plotted in FIG. 6 as a function of immersion time. In the solvents hexane, xylene and ethyl acetate, the core extracts slowly from the DL microcapsule through 5 days followed by achievement of a stable plateau due to osmotic balance. Solvent polarity affects the microcapsules stability as greater and more rapid loss of core mass is observed in more polar solvents. Although some leakage occurs, microcapsules still reserved most core material and remained stable in most organic solvents. With an immersion duration of 20 days, the residual core fractions of DL microcapsules is 71.1±0.3 wt % in hexane, 67.9±0.7 wt % in xylene, and 65.6±0.5 wt % in ethyl acetate. Additionally, all microcapsules remain spherical. Even in the most polar solvent, acetone, after 24 h, DL microcapsules retain 56.4±0.4 wt % core and a spherical shape although all core is extracted from the DL microcapsule after 48 h. No state of the art microcapsules for diisocyanates are stable in acetone for more than 1 h.

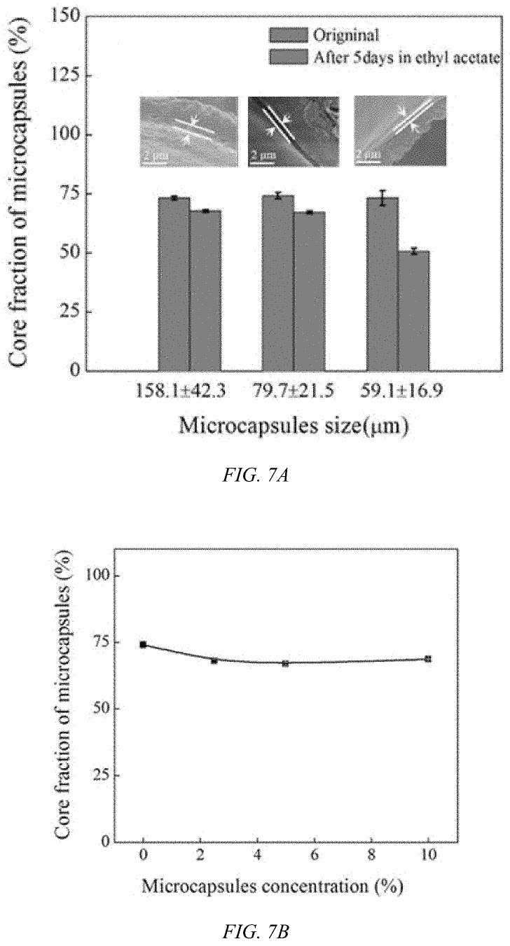

DL microcapsules of various diameters immersed in ethyl acetate for 5 days to demonstrate stability based on the PUF shell thickness. As shown in FIG. 7A, the core mass fraction of residual microcapsules with diameters of 158±42 μm, 80±22 μm and 60±17 μm decrease by 7.5%, 9.6%, and 30.7%, upon soaking for these DL microcapsules with PUF shell thicknesses of 422±36 nm, 387±40 nm, and 309±27 nm, respectively. Leakage is consistent with more leakage through thinner PUF shells. The influence of DL microcapsule concentration on the stability in the presence of solvents, as shown in FIG. 7B, does not appear to suggest that a partitioning equilibrium is established with sufficiently high concentrations for the DL microcapsules within the range examined, as concentrations of 2.5 wt %, 5 wt % and 10 wt %, display equivalent core mass fractions of 68.0±0.8 wt %, 67.0±0.6 wt %, and 68.7±0.1 wt %, respectively.

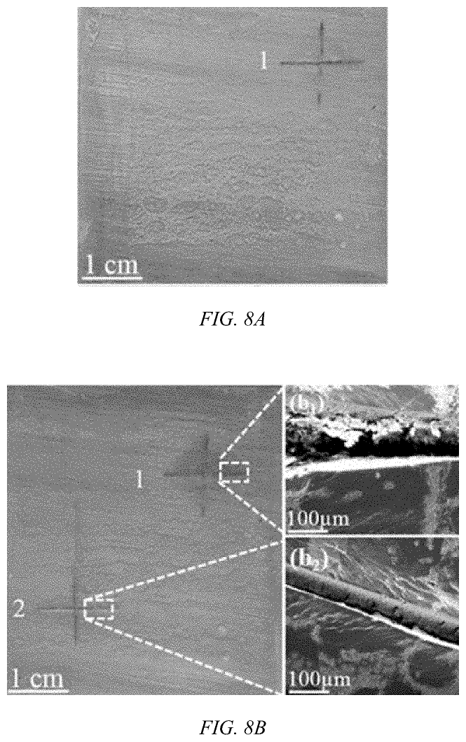

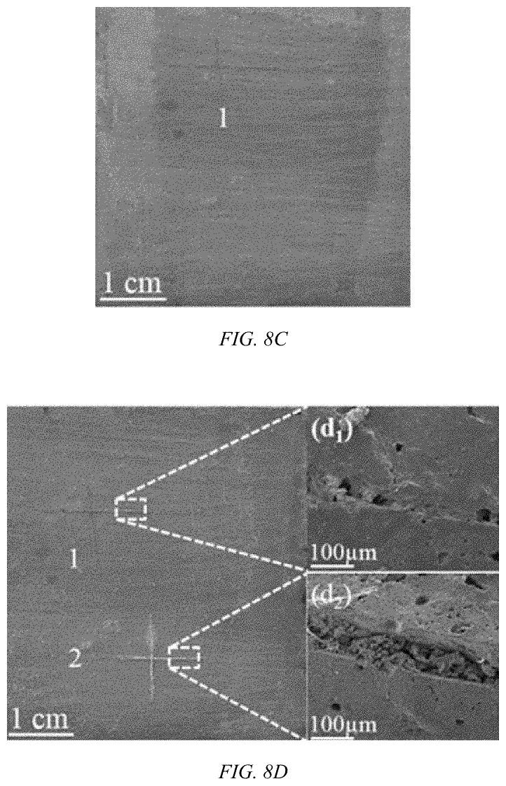

In an embodiment of the invention, the DL microcapsules can be dispersed in coatings used for metals. Metals can include, steel, iron, aluminum, brass or any other metal or metal alloy. The coatings can be epoxy coatings, poly urethane coatings, polyester coatings, or any other polymeric coating. Self-healing of self-healing coatings comprising the DL microcapsules is reflected by the corrosion on a series of scratches on epoxy coated steel substrates. Severe corrosion occurred with control samples of DL microcapsule free epoxy coated steel substrates, as shown in FIGS. 8A and 8B, after 20 days of immersion in salt water. In contrast, the self-healing coated steel substrates present no visible corrosion evidence, as shown in FIGS. 8C and 8D, due to the release of HMDI from damaged microcapsules polymerize with moisture to seal the scratches. After long-term storage (20 days) in water a second scratch, number 2 in FIGS. 8A and 8B, demonstrated the stability of the DL microcapsules and the continued protection afforded by the self-healing coating on the steel substrates. The second scratch seals completely after submersion in salt water, while that of the epoxy coated steel substrate displays rust.

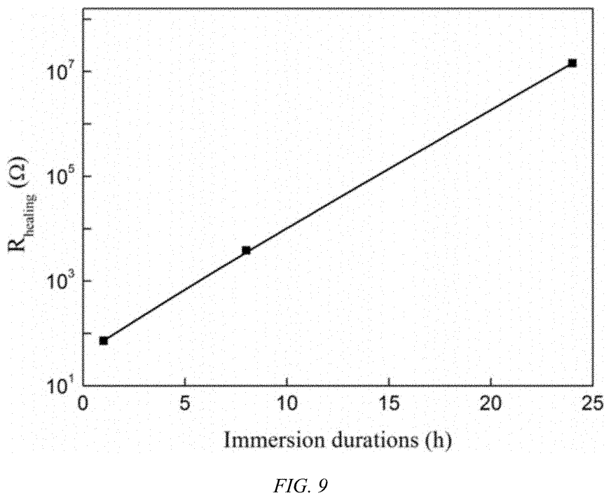

Electrochemical Impedance Spectroscopy (EIS) experiments provide additional evidence of the self-healing properties of the self-healing coatings. As shown in FIG. 9, the self-healing process is accompanied with the increase of coating resistance, which rises greatly from 72.5Ω to 1.5×10⁷Ω when the immersion durations were extended from 1 to 24 h.

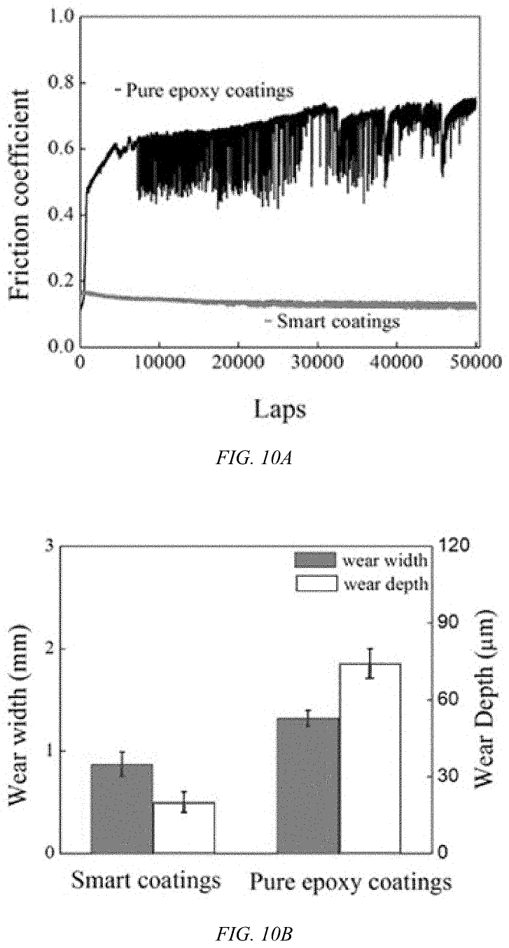

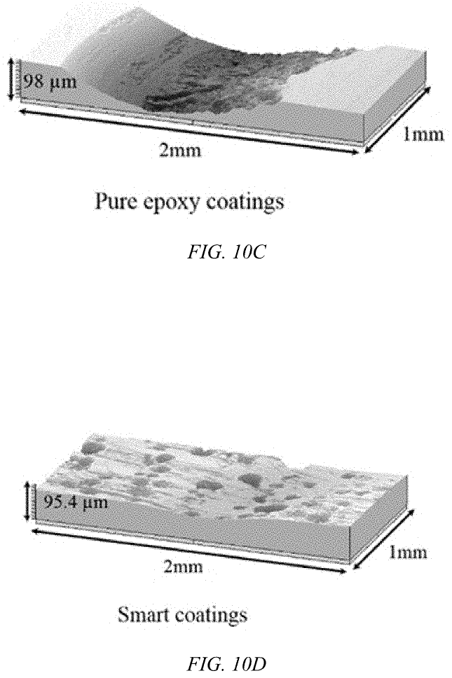

Self-lubrication result from the self-healing coatings on a substrate. FIG. 10a shows the friction coefficient of samples as a function of wear laps. The friction coefficient of self-healing coated substrates decreases with wear laps due to the release of additional HMDI, while the frictional coefficient of pure epoxy coated samples increases, as evident by a growing contact interface and a greater mechanical interlock. Microcapsules debris is observed clearly on the wear track of self-healing coatings. The average friction coefficient of self-healing coatings was 0.136, while that of control samples is 0.644. The friction coefficient of self-healing coatings decreases by 78.9% because of the great lubricating action of HMDI. The wear losses of samples is characterized by wear width and wear depth, which were obtained from the profile of wear track based on at least 10 points, as shown in FIG. 10B. The wear width and wear depth of self-healing coatings of 0.9±0.1 mm and 20.0±4.1 μm, differed from the 1.3±0.1 mm and 74±36 1μm, of the control samples. The profiles of epoxy coated substrates and self-healing coating covered substrates are clear for the epoxy and self-healing coating surfaces, as shown in FIGS. 10C and 10D, respectively.

### Materials and Methods

### Materials

4,4-Diphenylmethane diisocyanate prepolymer (Suprasec 2644) was obtained from Huntsman. HMDI, tetraethylenepentamine (TEPA), gum Arabic, formaldehyde aqueous solution (35-37 wt %), urea, resorcinol, ethylene maleic anhydride (EMA), hydrogen chloride (HCl, 0.1 M), sodium hydroxide (NaOH), sodium chloride (NaCl), hexane, xylene, ethyl acetate and acetone were purchased from Sigma-Aldrich. Epolam 5015 and hardener 5014 were purchased from Axson. All chemicals in this investigation were used as received without further purification.

### Formation of Microcapsules

The synthesis of microcapsules was divided into two steps. Polyurea (PU) shells were synthesized through interfacial reaction (IL-microcapsules), followed by depositing a layer of poly-urea-formaldehyde resin (PUF) on the PU shell via in situ polymerization (DL-microcapsules).

A 1.5 g portion of Suprasec 2644 a methylene diphenyl diisocyanate (MDI) prepolymer, was dissolved uniformly into 13.5 g of HMDI as oil phase and emulsified into micro-droplets in 90 mL of gum Arabic aqueous solutions (2.5 wt %) at 30° C. under mechanical agitation of 650 RPM. The emulsion was stabilized for 45 min. Subsequently, 54 g of tetraethylenepentamine (TEPA) aqueous solution (30 wt %) was slowly added and the temperature was raised to 65° C. After 60 min, the IL-microcapsules slurry was decanted and rinsed four times with deionized (DI) water.

A urea-formaldehyde (UF) prepolymer was synthesized by reacting 18.99 g of a formaldehyde aqueous solution with 7.5 g of urea at pH 7.5-8.5 at 70° C. for 1 h. The UF prepolymer, 4.5 g of resorcinol and 180 mL of EMA aqueous solutions (1.25 wt %) were mixed with the IL-microcapsules slurry with an agitation rate of 200 RPM and with the pH of the mixture adjusted to 3.0. After 50 min at room temperature, the system was heat to 55° C. for 2 h. The suspension of DL-microcapsules was rinsed with DI water for several times, and dried in air for 12 h.

Using agitation rates of 450 RPM, 650 RPM and 850 RPM during the emulsification process, the diameters of corresponding DL-microcapsules were 158±42 μm, 80±22 μm, and 59±17 μm, respectively. Unless otherwise specified, DL-microcapsules have a diameter of 80±22 μm were used in exemplary formulations.

### Permeability of Different Shell Layer

In order to study the permeability of PU and PUF shells of IL-microcapsules and DL-microcapsules, respectively, microcapsules were stored in ambient water for 20 days and in hexane for 5 days at a concentration of 5 wt %, and characterized in terms of morphologies and residual core fractions.

### Stability of Microcapsules in Organic Solvents

Typical microcapsules were placed in ambient hexane (Polarity: 0), xylene (Polarity: 1.4) and ethyl acetate (Polarity: 5.3) at a concentration of 5 wt % for 5 days, 10 days, and 20 days, respectively. Microcapsules placed in acetone (Polarity: 10.4), were examined with immersion durations of 3 h, 24 h and 48 h, respectively. Microcapsules with different diameters (158±42 μm, 80±22 μm, 59±17 μm) were immersed in ambient ethyl acetate for 5 days at a concentration of 5 wt %. Microcapsules of 80±22 μm were soaked in ethyl acetate at different concentrations (2.5 wt %, 5 wt % and 10 wt %) for 5 days.

### Formation of Self-Healing Coatings

Self-healing coatings were prepared by dispersing uniformly 10 wt % conditioned microcapsules in pure epoxy resin, which was prepared by formulating Epolam 5015 and hardener 5014 at a mass ratio of 3:1, followed by degassing under vacuum for 20 min. Fresh microcapsules were stored in ambient ethyl acetate for 5 days to obtain conditioned microcapsules after dry.

### Test of Self-Healing Samples

Self-healing samples were fabricated by covering sanded, water washed, and acetone washed steel panels (50×50×2 mm³) with the self-healing coating. The coating thickness was within 300-400 μm after cure. After ambient cure for 24 h, scratches (Labeled as No. 1) were created by razor blades on one portion of the panel and the panel soaked in 1 M NaCl aqueous solutions for 20 days. Subsequently, additional scratches (Labeled as No. 2) were scribed manually at a previously unscratched portion of the same panels followed by immersion in the NaCl solution for an additional 24 h. The morphologies of scratches were imaged through FESEM.

Electrochemical testing was used to observe any self-healing process. The self-healing samples were stored in NaCl aqueous solutions (1 M) for 20 days before manual scribing. The scratched samples were tested by EIS experiments (Gamry Reference 600 potentiostat) in 1 M NaCl aqueous solutions. The swept frequency and AC amplitude was set as 10⁻²-10⁵ and 20 mV, respectively.

### Test of Self-Lubricating Samples

Tribological test was applied to analyze self-lubricating properties of samples prepared by adding resins in a PTFE cylindrical mold with diameters of 30 mm. After cure for 24 h at room temperature, the surfaces of samples were rubbed with 4000 mesh sand paper and flushed with water and ethanol prior to tribological test.

Tribological tests were conducted by rolling a steel ball (Cr6, 6 mm in diameter) on the samples' surfaces through a ball-on-disc micro-tribometer (CSM), and the diameter of the circular wear track was set as 3 mm. The experimental parameters were: load=3 N; velocity=5 cm/s; and wear laps=50,000 laps. The friction coefficient, wear width, and wear depth were measured for all samples. Wear depth and wear width of wear track were obtained through surface profilometry, and results were obtained based on the average value of at least twelve tests.

All publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A DL microcapsule, comprising a core comprising a liquid diisocyanate comprising molecule and a double layer shell, where the double layer shell comprises an inner layer comprising a polyurea (PU) and an outer layer comprising a poly(urea formaldehyde) foam (PUF).

2. The DL microcapsule according to claim 1, wherein the liquid diisocyanate comprising molecule is 4,4′-bis-methylene cyclohexane diisocyanate or hexamethylene diisocyanate.

3. The DL microcapsule according to claim 1, wherein the diameter is 50 to 200 μm.

4. The DL microcapsule according to claim 1, wherein the thickness of the double layer shell is 300 to 450 nm.

5. The DL microcapsule according to claim 1, wherein the PU is the network from the addition of 4,4-Diphenylmethane diisocyanate prepolymer, 4,4′-bis-methylene cyclohexane diisocyanate and tetraethylenepentamine.

6. A self-healing coating, comprising a multiplicity of DL microcapsules according to claim 1 and a polymeric matrix.

7. The self-healing coating according to claim 6, wherein the polymeric matrix is an epoxy matrix.

8. The self-healing coating according to claim 7, wherein the epoxy matrix comprises the addition product from 2,2-Bis(4-glycidyloxyphenyl)propane and isophorone diamine.

9. A method of forming a self-healing coated substrate, comprising:
providing a substrate;
providing an polymeric resin;
providing a multiplicity of DL-microcapsules according to claim 1;
combining the DL-microcapsules and the polymeric resin to form a coating precursor;
dispersing the coating precursor on the substrate; and
curing the epoxy resin to form the self-healing coating comprising a multiplicity of DL microcapsules according to claim 1 and a polymeric matrix on the substrate, wherein the self-healing coated substrate is capable of resisting corrosion when abraded.

10. The method according to claim 9, wherein the substrate is a metal substrate.

11. The method according to claim 9, wherein the metal substrate is an iron or steel substrate.

12. The method according to claim 9, wherein the polymeric resin is an epoxy resin.
